(19) United States
(12) Patent Application Publication
(10) Pub. No.: US 2019/0172441 A1
(43) Pub. Date: Jun. 6, 2019

(54) PASSIVE SOUND ENHANCEMENT SYSTEM FOR A VEHICLE

(71) Applicant: GM Global Technology Operations LLC, Detroit, MI (US)

(72) Inventors: Frank C. Valeri, Novi, MI (US); Scott M. Reilly, Southfield, MI (US); John Miller, Howell, MI (US); Song He, Troy, MI (US)

(21) Appl. No.: 15/831,994

(22) Filed: Dec. 5, 2017

(51) Int. Cl. G10K 11/24; B60K 6/405; B60K 7/00

(52) U.S. Cl. CPC G10K 11/24; F02M 35/1294; B60K 7/0007; B60K 6/405

(57) ABSTRACT

A powertrain component for a vehicle including a housing, and a mechanical system arranged in the housing. The mechanical system provides motive power to the vehicle. A passive sound enhancement system includes a bracket mounted to the housing. The bracket is selectively tuned to respond to one or more selected frequencies of the powertrain component.

### INTRODUCTION

The subject disclosure relates to vehicles and, more particularly, to a passive sound enhancement system for a vehicle.

Advancements in sound attenuation techniques, and changes in component technology have, at times, made it more difficult for vehicle occupants to perceive sounds produced by vehicle components. Vehicle owners have come to expect certain sounds in a vehicle interior. That is, some owners rely on sounds, produced by various vehicle components, to identify proper operation, or a certain level of vehicle performance. Accordingly, it is desirable to provide a system that promotes desirable sound transmission from vehicle components to vehicle occupant spaces.

### SUMMARY

Disclosed is a powertrain component for a vehicle including a housing, and a mechanical system arranged in the housing. The mechanical system provides motive power to the vehicle. A passive sound enhancement system includes a bracket mounted to the housing. The bracket is selectively tuned to respond to one or more selected frequencies of the powertrain component.

In addition to one or more of the features described herein, exemplary embodiments could include another bracket mountable at an occupant compartment of the vehicle, and a sound transmitting device extending between and connecting the bracket and the another bracket.

In addition to one or more of the features described herein, exemplary embodiments could include wherein the sound transmitting device comprises a cable.

In addition to one or more of the features described herein, exemplary embodiments could include wherein the sound transmitting device comprises a sheathed cable.

In addition to one or more of the features described herein, exemplary embodiments could include wherein the sound transmitting device comprises a vehicle control cable.

In addition to one or more of the features described herein, exemplary embodiments could include wherein the bracket includes a cantilevered end.

In addition to one or more of the features described herein, exemplary embodiments could include wherein the cantilevered end supports a mass.

In addition to one or more of the features described herein, exemplary embodiments could include wherein the mass is connected to the cantilevered end through a resilient member.

In addition to one or more of the features described herein, exemplary embodiments could include wherein the mass includes a selected size and weight that possess a selected response when exposed to the one or more selected frequencies of the powertrain component.

In addition to one or more of the features described herein, exemplary embodiments could include wherein the mechanical system comprises an electric motor.

Also disclosed is a vehicle having a body including an occupant compartment, and a powertrain component supported in the body for providing motive power to the vehicle. The powertrain component includes a housing, a mechanical system arranged in the housing, and a bracket mounted to the housing. The bracket is selectively tuned to respond to one or more selected frequencies of the powertrain component.

In addition to one or more of the features described herein, exemplary embodiments could include another bracket mountable at an occupant compartment of the vehicle, and a sound transmitting device extending between and connecting the bracket and the another bracket.

In addition to one or more of the features described herein, exemplary embodiments could include wherein the sound transmitting device comprises a cable.

In addition to one or more of the features described herein, exemplary embodiments could include wherein the sound transmitting device comprises a sheathed cable.

In addition to one or more of the features described herein, exemplary embodiments could include wherein the sound transmitting device comprises a vehicle control cable.

In addition to one or more of the features described herein, exemplary embodiments could include wherein the mechanical system comprises an electric motor.

In addition to one or more of the features described herein, exemplary embodiments could include wherein the bracket includes a cantilevered end.

In addition to one or more of the features described herein, exemplary embodiments could include wherein the cantilevered end supports a mass.

In addition to one or more of the features described herein, exemplary embodiments could include wherein the mass includes a selected size and weight that possess a selected response when exposed to the one or more selected frequencies of the powertrain component and is connected to the cantilevered end through a resilient member.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a vehicle having a passive sound enhancement system, in accordance with an aspect of an exemplary embodiment;

FIG. 2 schematically illustrates the passive sound enhancement system of FIG. 1, in accordance with an aspect of an exemplary embodiment;

FIG. 3 schematically depicts a passive sound enhancement system, in accordance with another aspect of an exemplary embodiment; and

FIG. 4 schematically depicts a passive sound enhancement system, in accordance with yet another aspect of an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

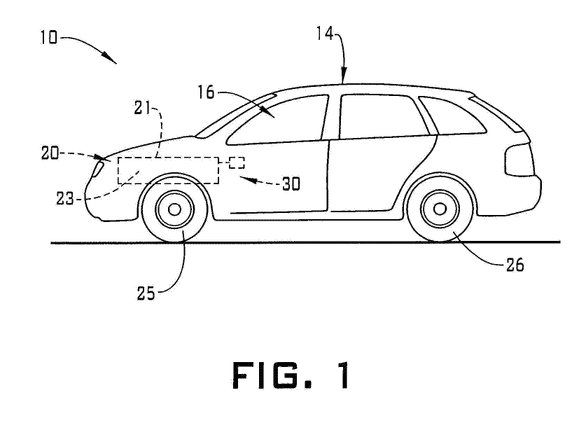

A vehicle, in accordance with an aspect of an exemplary embodiment, is indicated generally at 10 in FIG. 1. Vehicle 10 includes a body 14 that defines, at least in part, an occupant compartment 16. Body 14 also supports a powertrain component 20 having a housing 21 that encloses a mechanical system (not separately labeled). Powertrain component 20 may take the form of an electric motor 23 that provides motive power to vehicle 10. Powertrain component 20 may also take on other forms including internal combustion engines, electric powertrains, and/or components thereof. Also, the term “electric motor” should be understood to include both dedicated electric and hybrid electric motors. Powertrain component 20 provides a motive force to vehicle 10 through front wheels 25 and/or rear wheels 26. That is, powertrain component 20 may be operatively connected to one, the other, or both front wheels 25 and rear wheels 26 through a transmission (not shown).

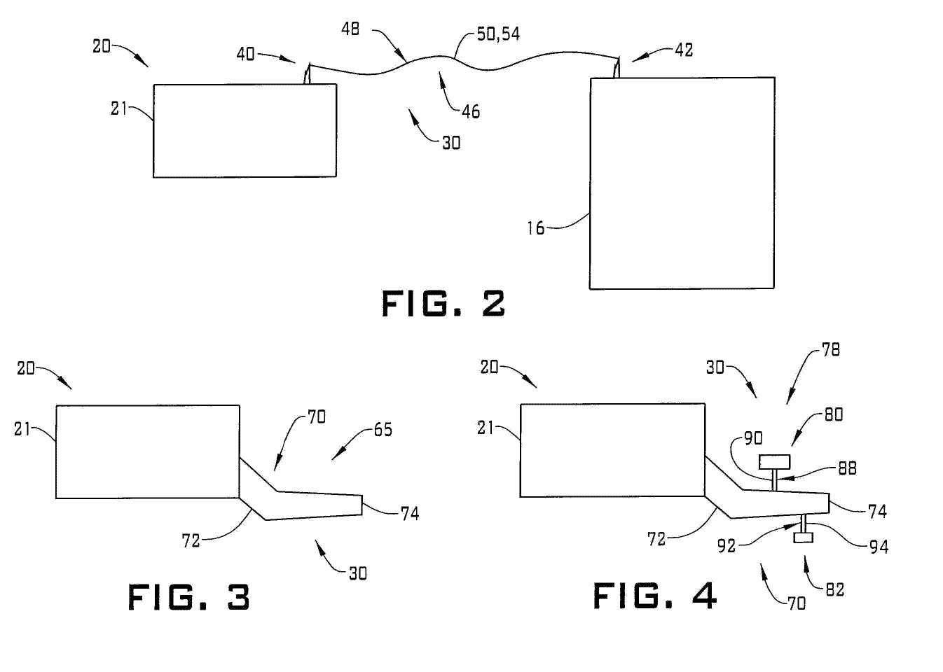

In accordance with an aspect of an exemplary embodiment, vehicle 10 includes a passive sound enhancement system 30 that enhances acoustics that may be created by powertrain component 20 so as to be perceivable in occupant compartment 16. With reference to FIG. 2 and continued reference to FIG. 1, passive sound enhancement system 30, in accordance with an exemplary aspect, includes a first bracket 40 mounted to powertrain component 20 and a second bracket 42 mounted at occupant compartment 16. The phrase “mounted at occupant compartment 16” should be understood to mean that second bracket 42 may be mounted in or near occupant compartment 16.

In accordance with an exemplary aspect, first bracket 40 is designed and formed to be responsive to a selected vibrational frequency or range of frequencies produced by powertrain component 20. When exposed to the selected frequency or range of frequencies, first bracket 40 may resonate at the same frequency or range of frequencies or at a different frequency or range of frequencies. First bracket 40 is connected to second bracket 42 by a sound transmitting device 46 that may take the form of a cable 48. In accordance with an exemplary aspect, cable 48 may be a sheathed cable 50. In accordance with another exemplary aspect, cable 48 may take the form of a vehicle control cable 54. The phrase “vehicle control cable” should be understood to describe a cable whose primary purpose is to provide and/or monitor control functions in vehicle 10.

Sound transmitting device 46 carries vibrations from first bracket 40 to second bracket 42. Second bracket 42 may then vibrate at a selected frequency or range of frequencies in response to the vibrations received from first bracket 40. The vibrations may resonate and may be perceivable as sounds in occupant compartment 16. The sounds are selected to provide a particular occupant experience. At this point, it should be understood that the first and second brackets 40 and 42 may be selectively dedicated to sound enhancement or, in accordance with another aspect, may take on multiple roles including sound enhancement and, for example, support members.

Reference will now follow to FIG. 3 in describing a sound shaping system 65 in accordance with another aspect of an exemplary embodiment. Sound shaping system 65 includes a bracket 70 having a first end 72 mounted to powertrain component 20 and a second, cantilevered end 74. Bracket 70 is formed from a material and is shaped so as to respond to a selected vibrational frequency or range of frequencies produced by powertrain component 20. Bracket 70 will resonate and produce an audible response when exposed to the selected frequency or range of frequencies. The audible response is perceivable in occupant compartment 16.

Reference will now follow to FIG. 4, wherein like reference numbers represent corresponding parts in the respective views, in describing a passive sound enhancement system 78 in accordance with another exemplary aspect. Passive sound enhancement system 78 includes a first mass 80 mounted to a first side (not separately labeled) of cantilevered end 74 and a second mass 82 mounted to a second, opposing side (also not separately labeled) of cantilevered end 74. It should be understood, that while shown with two masses, passive sound enhancement system 78 may only include a single mass. Second mass 82 may include a size and a weight selected to respond when exposed to the selected frequency or range of frequencies.

In the exemplary aspect shown, first mass 80 is connected to second cantilevered end 74 through a first resilient member 88 which may take the form of a spring 90. Similarly, second mass 82 may be connected to cantilevered end 74 through a second resilient member 92 which may take the form of a second spring 94. First and second masses 80, 82, together with first and second resilient members 88 and 92 are selected so as to enhance the audible response which may be perceived in occupant compartment 16 when bracket 70 is exposed to the selected vibrational frequency or range of frequencies.

At this point, it should be understood that the exemplary embodiments provide a system that enhances sound produced by selected power components such as an electric motor, an internal combustion engine, or other propulsion system component, so as to be perceivable in an occupant compartment of a vehicle. The system relies on mechanical technology and does not require any electrical intervention. The use of resonating brackets that may be coupled with a sound transmission device may enhance, and transport sounds from the electric motor to one or more elements located in or near the occupant compartment. Other systems may simply rely on a motor mounted bracket that may resonate at a selected frequency.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A powertrain component for a vehicle comprising:
a housing;
a mechanical system arranged in the housing, the mechanical system providing motive power to the vehicle; and
a passive sound enhancement system including a bracket mounted to the housing, the bracket being selectively tuned to respond to one or more selected frequencies of the powertrain component.

2. The powertrain component according to claim 1, further comprising:
another bracket mountable at an occupant compartment of the vehicle; and
a sound transmitting device extending between and connecting the bracket and the another bracket.

3. The powertrain component according to claim 2, wherein the sound transmitting device comprises a cable.

4. The powertrain component according to claim 2, wherein the sound transmitting device comprises a sheathed cable.

5. The powertrain component according to claim 2, wherein the sound transmitting device comprises a vehicle control cable.

6. The powertrain component according to claim 1, wherein the bracket includes a cantilevered end.

7. The powertrain component according to claim 6, wherein the cantilevered end supports a mass.

8. The powertrain component according to claim 7, wherein the mass is connected to the cantilevered end through a resilient member.

9. The powertrain component according to claim 6, wherein the mass includes a selected size and weight that possess a selected response when exposed to the one or more selected frequencies of the powertrain component.

10. The powertrain component according to claim 1, wherein the mechanical system comprises an electric motor.

11. A vehicle comprising:
a body including an occupant compartment; and
a powertrain component supported in the body for providing motive power to the vehicle, the powertrain component comprising:
a housing;
a mechanical system arranged in the housing; and
a bracket mounted to the housing, the bracket being selectively tuned to respond to one or more selected frequencies of the powertrain component.

12. The vehicle according to claim 11, further comprising:
another bracket mountable at the occupant compartment of the vehicle; and
a sound transmitting device extending between and connecting the bracket and the another bracket.

13. The vehicle according to claim 12, wherein the sound transmitting device comprises a cable.

14. The vehicle according to claim 12, wherein the sound transmitting device comprises a sheathed cable.

15. The vehicle according to claim 12, wherein the sound transmitting device comprises a vehicle control cable.

16. The vehicle according to claim 12, wherein the mechanical system comprises an electric motor.

17. The vehicle according to claim 11, wherein the bracket includes a cantilevered end.

18. The vehicle according to claim 17, wherein the cantilevered end supports a mass.

19. The vehicle according to claim 18, wherein the mass includes a selected size and weight that possess a selected response when exposed to the one or more selected frequencies of the powertrain component and is connected to the cantilevered end through a resilient member.
